(19) United States
(12) Patent Application Publication
(10) Pub. No.: US 2026/0358543 A1
(43) Pub. Date: Nov. 12, 2026

(54) Multilayer Optical Film and Display System Including Same

(71) Applicant: 3M INNOVATIVE PROPERTIES COMPANY, St. Paul, MN (US)

(72) Inventors: Lin Zhao, Woodbury, MN (US); Raghunath Padiyath, Woodbury, MN (US); Samuel A. Minno, St. Paul, MN (US)

(21) Appl. No.: 19/514,952

(22) PCT Filed: Sep. 11, 2024
(86) PCT No.: PCT/IB2024/058838

§ 371 Date: Feb. 27, 2026

Related U.S. Application Data
(60) Provisional application No. 63/582,866, filed on Sep. 15, 2023.

(51) Int. Cl. G02B 5/30

(52) U.S. Cl. CPC G02B 5/305; G02B 5/3066

(57) ABSTRACT

A multilayer optical film includes a plurality of optical repeat units. For an angle of incidence less than about 10 degrees and for each of two mutually orthogonal polarization states, the multilayer optical film has a first order reflection band comprising an average reflectance of greater than about 70 percent in an infrared wavelength range and an average reflectance of less than about 15 percent in a visible wavelength range. For a p-polarized incident light and a predetermined angle of incidence, the multilayer optical film has an average reflectance in a range of about 18 percent to about 35 percent in the visible wavelength range where a standard deviation of reflectance of the multilayer optical film over the visible wavelength range is less than about 0.15 times the average reflectance in the visible wavelength range. A display system includes the optical film and an image projector.

### TECHNICAL FIELD

The present description relates generally to multilayer optical films and display systems.

### BACKGROUND

A multilayer optical film can include a stack of polymeric layers arranged into optical repeat units. The multilayer optical film can be a reflective polarizer or a mirror. A display system can include an image projector and a multilayer optical film.

### SUMMARY

In some aspects, the present description provides a multilayer optical film including a plurality of optical repeat units numbering greater than about 10 in total. Each of the optical repeat units include a plurality of polymeric layers. Each polymeric layer of each optical repeat unit can have an average thickness of less than about 500 nm. The multilayer optical film is such that for incident light having an angle of incidence less than about 10 degrees and for each of two mutually orthogonal polarization states, the multilayer optical film has: a first order reflection band comprising an average reflectance of greater than about 70 percent in an infrared wavelength range extending at least from about 1000 nm to about 1600 nm where a standard deviation of reflectance of the multilayer optical film over the infrared wavelength range is less than about 0.05 times the average reflectance in the infrared wavelength range; and an average reflectance of less than about 15 percent in a visible wavelength range of about 420 nm to about 680 nm. The multilayer optical film is such that for a p-polarized incident light in an incident plane and for a predetermined angle of incidence in a range of about 45 degrees to about 75 degrees, the multilayer optical film has an average reflectance in a range of about 18 percent to about 35 percent in the visible wavelength range where a standard deviation of reflectance of the multilayer optical film over the visible wavelength range is less than about 0.15 times the average reflectance in the visible wavelength range.

In some aspects, the present description provides a multilayer optical film including a plurality of optical repeat units numbering greater than about 10 in total. Each of the optical repeat units can have an average total thickness of less than about 1 micrometer and can include at least four sequentially arranged first through fourth individual layers. For each of the optical repeat units, the first through fourth individual layers can have respective f-ratios f1 through f4 for respective indices of refraction nx1 through nx4 in a same in-plane x-direction, where each of f1 and f3 is in a range of about 0.28 to about 0.4, and each of f2 and f4 is in a range of about 0.1 to about 0.22. The multilayer optical film can be such that for a p-polarized incident light in an incident plane comprising the x-direction, for an angle of incidence less than about 10 degrees, the multilayer optical film has: a first order reflection band comprising an average reflectance of greater than about 70 percent in an infrared wavelength range extending at least from about 1000 nm to about 1600 nm; and an average reflectance of less than about 15 percent in a visible wavelength range of about 420 nm to about 680 nm. The multilayer optical film can be such that for a p-polarized incident light in an incident plane comprising the x-direction and for a predetermined angle of incidence in a range of about 45 degrees to about 75 degrees, the multilayer optical film has an average reflectance in a range of about 18 percent to about 35 percent in the visible wavelength range.

In some aspects, the present description provides a display system including an automotive windshield and an image projector configured to project a p-polarized image light toward the automotive windshield. The automotive windshield includes a multilayer optical film including a plurality of optical repeat units numbering greater than about 10 in total. Each of the optical repeat units includes at least four sequentially arranged first through fourth individual layers. Each of the first through fourth individual layers of each optical repeat unit can have an average thickness of less than about 500 nm. A central ray of the p-polarized image light is in an incident plane and makes a predetermined angle of incidence with the automotive windshield. The predetermined angle of incidence can be in a range of about 45 degrees to about 75 degrees. For a p-polarized incident light in the incident plane and for the incident light incident on the automotive windshield at an angle of incidence less than about 10 degrees, the multilayer optical film has: has a first order reflection band comprising an average reflectance greater than about 70 percent in an infrared wavelength range extending at least from about 1000 nm to about 1600 nm; and an average reflectance of less than about 15 percent in a visible wavelength range of about 420 nm to about 680 nm. For a p-polarized incident light in the incident plane and for the incident light incident on the automotive windshield at the predetermined angle of incidence, the multilayer optical film has an average reflectance in a range of about 18 percent to about 35 percent in the visible wavelength range.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-section view of a multilayer optical film, according to some embodiments.

FIGS. 2-4 are plots of optical repeat unit (ORU) thickness versus ORU number for various multilayer optical films, according to some embodiments.

FIGS. 5-7 are plots of reflectance versus wavelength for various multilayer optical films, according to some embodiments.

FIG. 8 is a schematic cross-sectional view of a display system, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Vehicles can include a digital information display such as a head-up display (HUD). The HUD can present data on a transparent medium (e.g., the windshield) such that drivers can view the displayed information without looking away from the road ahead. Information including, for example, vehicle status, environmental conditions, and/or navigation guidance may be displayed via the HUD to enhance safety and driver comfort, for example. To project an image on the windshield, conventional HUD systems relies on Fresnel reflection from the air-glass interface of a windshield. Because the angle of incidence (often around 60 degrees) is typically close to the Brewster angle, p-pol reflection (reflection of light having a p-polarization state) is largely suppressed. Accordingly, in conventional HUD system, the image is formed by s-pol reflection (reflection of light having an s-polarization state) off the windshield.

Shortcomings of this conventional configuration include (1) ghost reflections occur unless a wedged adhesive layer is used in the laminated windshield to reduce the ghosting arising from double reflection; and (2) the projected s-pol image is blocked by common polarizing sunglasses. To address these shortcomings, a weak reflective polarizer with its block axis along p-pol light can be incorporated in the windshield to use as a combiner film. Such reflective polarizers allow the HUD image to be projected using p-pol light which does not result in ghost reflections and may be used with conventional polarizing sunglasses. However, conventional weak reflective polarizers lack solar heat rejection capability which may be desired to reduce energy consumption from air conditioning, for example. Furthermore, it may be desired to increase normal incidence transmittance through the combiner film for each of two mutually orthogonal polarization states.

According to some embodiments of the present description, a multilayer optical film is provided that provides both p-pol reflectivity for obliquely incident light and infrared reflectivity for solar energy rejection. The infrared reflectivity can be provided for at least one polarization state or for two mutually orthogonal polarization states in order to further increase the solar rejection. In some embodiments, for substantially normally incident light and for each of two mutually orthogonal polarization states, the multilayer optical film is substantially transmissive for visible light and substantially reflective for near infrared light. In some embodiments, for p-polarized incident light at a predetermined angle of incidence (e.g., corresponding to an angle of incidence utilized in a HUD system), the reflectivity is uniform. For example, a standard deviation of the reflectivity can be low, as described further elsewhere herein, in order to provide a reflected images having desired colorations. A standard deviation of the substantially normally incident near-infrared reflectivity may also be low in order to provide a uniform rejection of near-infrared solar radiation, for example.

As is known in the art, multilayer optical films including a plurality of optical repeat units (e.g., alternating first and second polymeric layers) can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); U.S. Pat. No. 9,162,406 (Neavin et al.); and U.S. Pat. No. 11,493,677 (Haag et al.), for example. An optical repeat unit of a multilayer optical film is generally the smallest distinct unit of optical layers that repeats along a thickness direction of the optical film. An optical repeat unit generally includes at least two different layers (e.g., higher index first and lower index second layers) and may optionally include additional layers as described in U.S. Pat. No. 5,103,337 (Schrenk et al.); U.S. Pat. No. 5,360,659 (Arends et al.); U.S. Pat. No. 5,540,978 (Schrenk); and U.S. Pat. No. 6,207,260 (Wheatley et al.), for example.

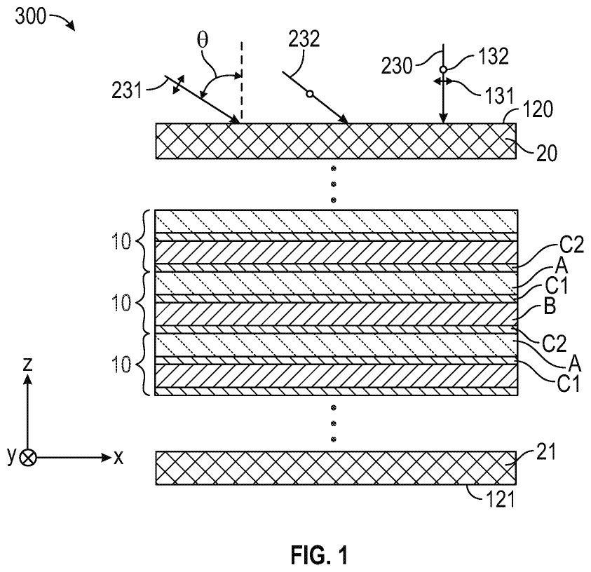

FIG. 1 is a schematic cross-section view of a multilayer optical film 300, according to some embodiments. The multilayer optical film 300 includes a plurality of optical repeat units 10. In some embodiments, each of the optical repeat units includes a plurality of polymeric layers (e.g., 2 to 8 or 4 to 6 polymeric layers). Each of the optical repeat units 10 can include at least four sequentially arranged first through fourth individual layers A, C1, B, C2, for example. The optical repeat units in the plurality of optical repeat units can number greater than about 10 in total. In some embodiments, the total number of the optical repeat units is at least 10, 20, 40, 60, 80, or 90, for example. In some embodiments, the total number of the optical repeat units is up to 400, 300, 250, 200, 180, 170, 160, or 150, for example. In some embodiments, the total number of optical repeat units is in a range of 80 to 150, for example. Incident lights 230, 231, and 232 in an incident plane (plane defined by light direction and surface normal) are schematically illustrated. Light 230 is substantially normally incident. Polarization states 131 and 132 are schematically illustrated. Light 232 has an s-polarization state 132 (electric field orthogonal to incident plane), and light 231 has a p-polarization state 131 (electric field in incident plane).

In some embodiments, the multilayer optical film 300 comprises a plurality of optical repeat units 10 where each of the optical repeat units includes a plurality of polymeric layers. In some embodiments, for each of the optical repeat units 10 of the plurality of optical repeat units, the plurality of polymeric layers comprises at least four sequentially arranged first through fourth individual layers A, C1, B, C2. In some embodiments, the first through fourth individual layers have respective first through fourth compositions. In some embodiments, the first and third compositions are different, and the second and fourth compositions are a same composition that is different from each of the first and third compositions. In some embodiments, each polymeric layer of each optical repeat unit 10, and/or each of the first through fourth individual layers of each optical repeat unit, has an average thickness of less than about 500, 450, 400, 350, 300, or 250 nm. In some embodiments, each polymeric layer of each optical repeat unit 10 has an average thickness of greater than about 30, 35, 40, 45, or 50 nm. In some embodiments, each of the optical repeat units has an average total thickness of less than about 1 micrometer or less than about 900, 850, 800, 750 or 700 nm. The average total thickness of each optical repeat unit can be greater than about 100, 150, 200, or 250 nm, for example. An average thickness of a layer is the average (mean) of the thickness over the area of the layer. The average total thickness of an optical repeat unit is the average (mean) of the sum of the thicknesses of the individual layers. The polymeric layers of the optical repeat units 10 may be referred to as optical layers, microlayers, or interference layers.

In some embodiments, the plurality of optical repeat units 10 is disposed on at least one layer 20, 21 having an average thickness greater than about 500, 750, 1000, 1500, or 2000 nm. Such layers may be referred to as macrolayers. Each of the at least one layer 20, 21 can have a thickness less than about 20, 10, or 5 micrometers, for example. In some embodiments, the plurality of optical repeat units 10 is disposed between macrolayers 20 and 21 having average thicknesses in any of these ranges (e.g., greater than about 1000 nm and less than about 20 micrometers). In some embodiments, the multilayer optical film 300 includes additional macrolayers (e.g., protective boundary layers), as would be appreciated by those of ordinary skill in the art.

In some embodiments, the plurality of optical repeat units 10 includes first and second pluralities of optical repeat units where the first and second pluralities are separated by at least one macrolayer. For example, the first and second pluralities can be separated by one or more protective boundary layers. In some embodiments, each of the first and second pluralities includes at least 10 optical repeat units. In some embodiments, each optical repeat unit of at least one of the first and second pluralities includes at least four sequentially arranged first through fourth individual layers A, C1, B, C2. In some embodiments, each optical repeat unit of the first plurality of optical repeat units includes at least four sequentially arranged first through fourth individual layers, and each optical repeat unit of the second plurality of optical repeat units includes at least two layers having different compositions (e.g., individual A and B layers). For example, the first plurality of optical repeat units can be used to reflect in an infrared wavelength range such that at least second and/or third order harmonics, if present, would be in a visible range, while the second plurality of optical repeat units can be used to reflect in a wavelength range (e.g., a different infrared wavelength range) where second and/or third order harmonics would not be in a visible range. In some embodiments, each optical repeat unit 10 of the multilayer optical film 300, or each optical repeat unit of at least 60, 70, 80, 85, 90, or 95 percent of all optical repeat units of the multilayer optical film 300, includes at least four sequentially arranged first through fourth individual layers A, C1, B, C2.

In some embodiments, the multilayer optical film 300 has an average total thickness of less than about 100, 95, 90, 85, 80, 75, 70, 65, or 60 micrometers. In some embodiments, the average total thickness is greater than about 40, 50, or 60 micrometers. For example, in some embodiments, the average total thickness is in a range of about 40 to about 100 micrometers, or in a range of about 50 to about 90 micrometers, for example. An average reflectance in a desired near-infrared wavelength range of greater than 97, 98, or even 99 percent can be obtained by increasing the number of optical repeat units and, correspondingly, increasing the overall thickness. The desired near-infrared wavelength can be an infrared wavelength range extending at least from about 1000 nm to about 1600 nm, for example. In some embodiments, an average reflectance in the desired near-infrared range may be reduced somewhat so that the thickness of the optical film can be in a desired range. For example, in some embodiments, for the p-polarized incident light, or for each of two mutually orthogonal polarization states, and for the angle of incidence less than about 10 degrees, the average reflectance in the infrared wavelength range is less than about 98, 97, 96, 95, 94, 93, 92, 91 or 90 percent. In some such embodiments, the multilayer optical film has an average thickness of less than about 100 micrometers or in a range described elsewhere herein.

An optical repeat unit generally results in a first order reflection of normally incident light at a wavelength of twice the optical thickness of the optical repeat units while higher order harmonics correspond to reflection at wavelengths 1/n times this wavelength for integer n>1. For example, a first order reflection at a wavelength of 1000 nm could lead to a second order reflection at a wavelength of 500 nm. The f-ratios can be chosen to suppress this second order reflection and other higher order reflections for substantially normally incident light. For obliquely incident light (e.g., at a predetermined angle of incidence), the second order reflection may be unsuppressed or only partially suppressed so that a first order reflection band in the near infrared wavelength range at substantially normal incidence results in a second order reflection band in the visible range for the predetermined angle of incidence. In some embodiments, for each of the optical repeat units: the first through fourth individual layers have respective f-ratios f1 through f4 for respective indices of refraction nx1 through nx4 in a same in-plane x-direction, where each of f1 and f3 is in a range of about 0.28 to about 0.4, and each of f2 and f4 is in a range of about 0.1 to about 0.22. For example, each of f1 and f3 can be about 1/3 while each of f2 and f4 can be about 1/6. F-ratios in these ranges are useful in suppressing higher order harmonics of a first order reflection band so that a first order reflection band in the near-infrared does not substantially affect visible light transmittance at normal incidence. Other f-ratios may be selected to suppress higher order harmonics. Suppression of higher order harmonics is described in U.S. Pat. No. 5,103,337 (Schrenk et al.); U.S. Pat. No. 5,360,659 (Arends et al.); U.S. Pat. No. 5,540,978 (Schrenk); and U.S. Pat. No. 6,207,260 (Wheatley et al.), for example, and in International Appl. Pub. No. WO 2022/195373 (Huseby et al.), for example.

Suitable materials for the various layers of the multilayer optical film 300 include polyethylene naphthalate (PEN), polyethylene terephthalate (PET), polycarbonate, polymethylmethacrylate (PMMA), copolyesters, and blends or copolymers thereof. Other suitable materials are described in the multilayer optical film references provided elsewhere herein. For example, PEN can be used as a high index layer (e.g., first individual layer A), PMMA can be used as a low index layer (e.g., third individual layer B), and a coPEN N/100−N can be used as intermediate index layers (e.g., second and third individual layers C1 and C2). As another example, PET can be used as a high index layer (e.g., first individual layer A), coPMMA can be used as a low index layer (e.g., third individual layer B), and a glycol-modified PET (PETg) can be used as intermediate index layers (e.g., second and third individual layers C1 and C2). CoPEN N/100−N can be described a copolyester where carboxylate units of the copolyester comprises N mole percent naphthalate units and 100−N mole percent terephthalate units and can be made as generally described in U.S. Pat. No. 6,946,188 (Hebrink et al.), for example. N can be in a range of about 50 to about 80 mole percent, for example. Glycol-modified PET can be described as PET with at least some of the glycol units replaced with different units such as those derived from cyclohexanedimethanol. Suitable PETg include PCTg and EASTAR GN071 (both available from Eastman Chemical Company, Knoxville, TN), for example.

In some embodiments, for each of the optical repeat units, the first through fourth individual layers have respective indices of refraction nx1 through nx4 in a same in-plane x-direction. In some embodiments, the incident plane (e.g., x-z plane) comprises the in-plane x-direction. In some embodiments, the first through fourth individual layers have respective indices of refraction ny1 through ny4 in a same in-plane y-direction orthogonal to the in-plane x-direction, and respective indices of refraction nz1 through nz4 in a same z-direction orthogonal to each of the in-plane x- and y-directions. In some embodiments, each of the first individual layers is birefringent. For example, in some embodiments, for at least one wavelength in the visible wavelength range, |nx1−nz1|>0.05, 0.06, 0.07, 008, 0.09, 0.1, 0.11, 0.12, 0.13, 0.14, 0.15, 0.16, 0.17, 0.18, 0.19, or 0.2. |nx1−nz1| can be up to 0.3, 0.28, or 0.26, for example. For typical birefringent polymers, nx1 is greater than nz1. In some embodiments, each of the first individual layers is biaxially birefringent. For example, in some embodiments, for at least one wavelength in the visible wavelength range, |nx1−ny1| is less than 0.03, 0.025, 0.02, 0.015, or 0.01 while |nx1−nz1| is greater than 0.05 or is in any of the ranges described elsewhere herein. In some embodiments, each of the second, third, and fourth individual layers is substantially isotropic. For example, in some embodiments, for at least one wavelength in the visible wavelength range and for each layer of the second, third, and fourth individual layers, a maximum birefringence of the layer (maximum difference in refractive indices of the layer in orthogonal directions) is less than 0.03, 0.025, 0.02, 0.015, or 0.01.

In some embodiments, for at least one wavelength in the visible wavelength range, each of |nx1−ny1|, |nx2−ny2|, |nx3−ny3|, |nx4−ny4| is less than 0.03; |nx1−nx3|>0.1; |nx2−nx4|<0.03; |nz1−nz3|<0.03; and |nz2−nz1|>0.05. In some embodiments, for at least one wavelength in the visible wavelength range, each of |nx1−ny1|, |nx2−ny2|, |nx3−ny3|, |nx4−ny4| is less than 0.025, 0.02, 0.015, or 0.01. In some embodiments, for at least one wavelength in the visible wavelength range, |nx1−nx3|>0.1, 0.12, 0.14, 0.16, 0.18, or 0.2. |nx1−nx3| can be up to 0.45, 0.4, 0.35, or 0.3, for example. In some embodiments, for at least one wavelength in the visible wavelength range, |nx2−nx4|<0.025, 0.02, 0.015, 0.01. In some embodiments, for at least one wavelength in the visible wavelength range, |nz1−nz3|<0.025, 0.02, 0.015, or 0.01. In some embodiments, for at least one wavelength in the visible wavelength range, |nz2−nz1|>0.06, 0.07, 008, 0.09, 0.1. |nz2−nz1| can be up to 0.4, 0.35, 0.3, or 0.25, for example. In some embodiments, for the at least one wavelength in the visible wavelength range, n1z and n3z are about equal (e.g., differ by less than 0.03), n2z and n4z are about equal, and the difference between n1z and n2z results in increased p-pol reflectance at a predetermined angle of incidence. In some embodiments, for the at least one wavelength in the visible wavelength range, nx2 and nx4 are each between nx1 and nx3. For example, each of nx2 and nx4 can be approximately (e.g., within 20, 15, 10, or 5%) a geometric mean of nx1 and nx3.

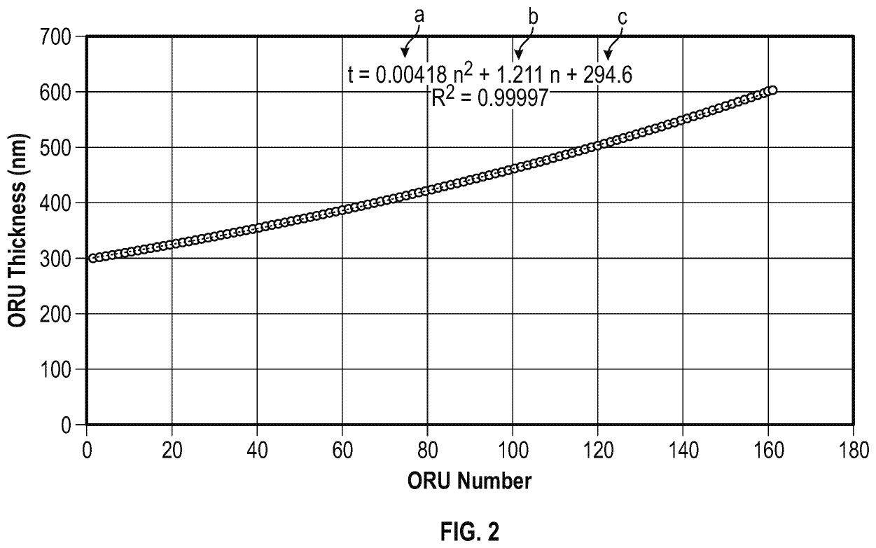

FIGS. 2-4 are plots of optical repeat unit (ORU) thickness versus ORU number for various multilayer optical films, according to some embodiments. The optical thickness profile can be selected to produce a desired reflectance in a desired wavelength range with a desire uniformity (e.g., low standard deviation of reflectance). In some embodiments, when the optical repeat units are sequentially numbered from the optical repeat unit closest to a outermost first major surface 120 of the multilayer optical film 300 to the optical repeat unit closest to an opposite outermost second major surface 121 of the multilayer optical film, a plot of thickness t of the optical repeat unit versus optical repeat unit number n has a best fit of the form t=a n²+b n+c with a coefficient of determination R² of at least 0.9, 0.92, 0.94, 0.95, 0.96, 0.97, 0.98, 0.99, 0.995, or 0.999, where a, b, and c are fit parameters. The best fit can be a least squares fit that minimizes the sum of squares of residuals where a residual is the difference between data and the fitted curve (e.g., polynomial). The least squares analysis allows the coefficient of determination R² to be determined. Equations of the form t=a n²+b n+c with the fit parameters determined via a least squares fit are shown in FIGS. 2-4 along with the coefficient of determination R². In some embodiments, a/b times the total number of optical repeat units is at least about 0.45, 0.47, 0.49, 0.51, or 0.53. In some embodiments, a/b times the total number of optical repeat units is no more than about 0.67, 0.65, 0.63, 0.61, or 0.59. For example, a/b times the total number of optical repeat units can be in a range of about 0.45 to about 0.67, or about 0.51 to about 0.61, or about 0.54 to about 0.58. In FIGS. 2-4, a/b times the total number of optical repeat units is 0.55961, 0.56201, and 0.56199, respectively. In some embodiments, the fit parameter a is a range of 0.003 to 0.012 nm, the fit parameter b is in a range of 0.9 to 2.5 nm, and the fit parameter c is in a range of 250 to 350 nm.

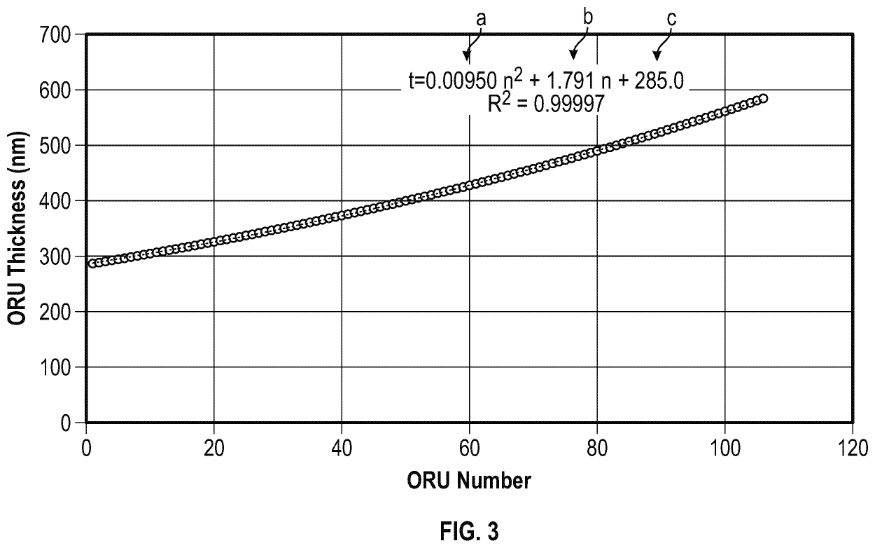

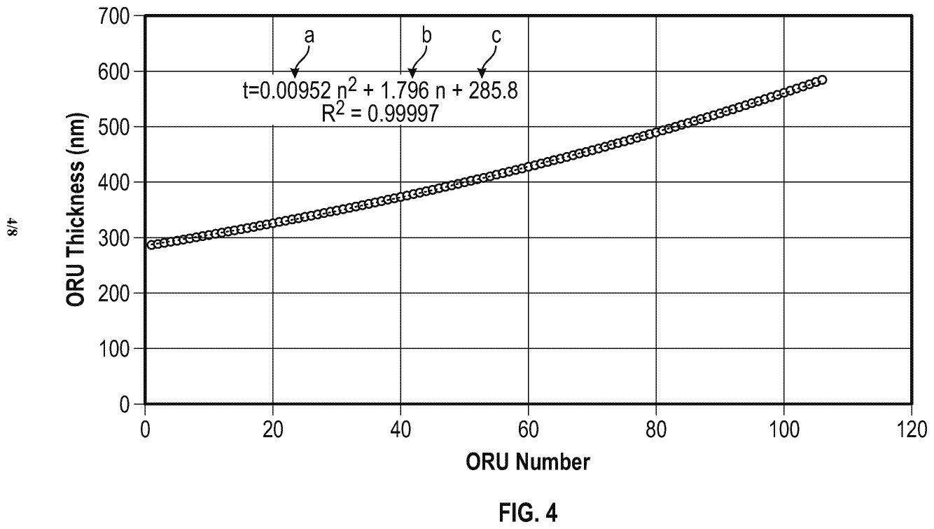

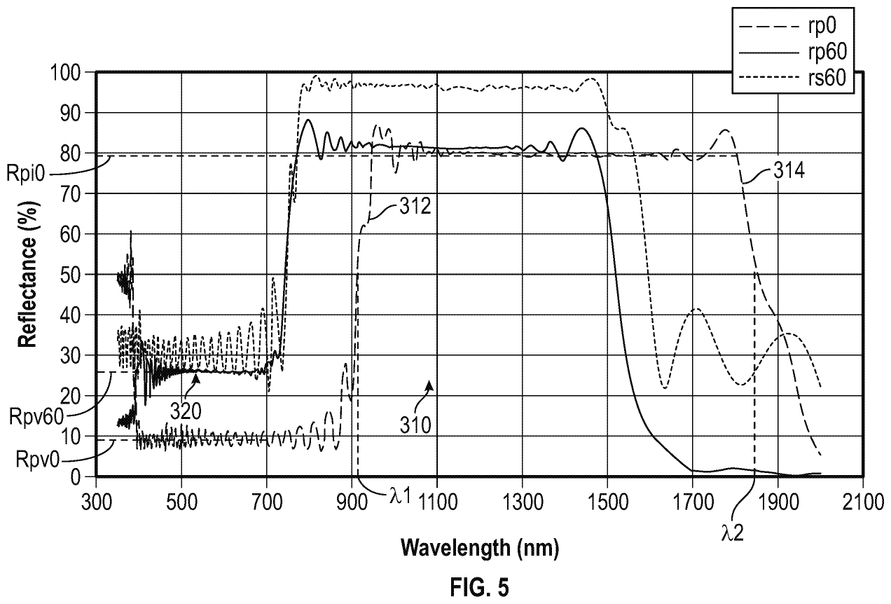

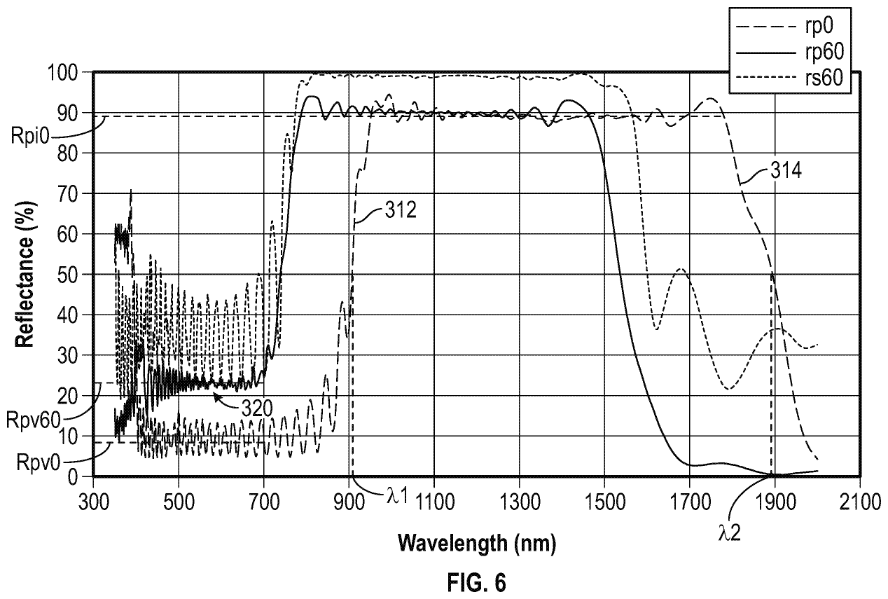

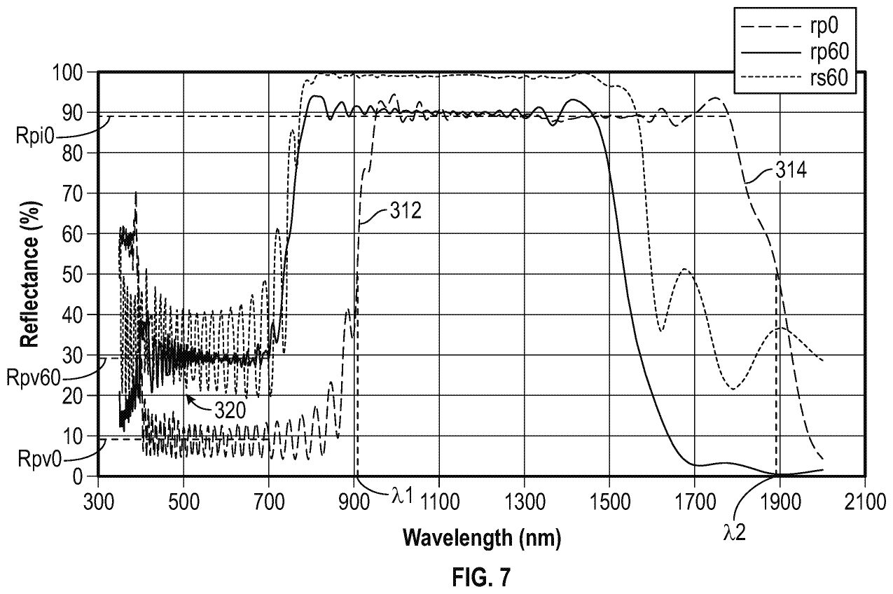

FIGS. 5-7 are plots of reflectance versus wavelength from various multilayer optical films, according to some embodiments. The plots were determined using standard optical modeling techniques. The films of FIGS. 5-7 had the optical repeat unit thickness profiles shown in FIGS. 2-4, respectively. In FIGS. 2 and 5, the first through fourth individual layers were modeled as PET, PETg, coPMMA, and PETg, respectively. In FIGS. 3 and 6, the first through fourth individual layers were modeled as PEN, coPEN 75/25, PMMA, and coPEN 75/25, respectively. In FIGS. 4 and 7, the first through fourth individual layers were modeled as PEN, coPEN 55/45, PMMA, and coPEN 55/45, respectively. The films were modeled as being biaxially stretched such that the PET and PEN layers were biaxially birefringent and the other layers were substantially isotropic. The table below provides average reflectances for p-polarized light Rpv0, Rpv60 and for s-polarized light Rsv0, Rsv60 for a visible wavelength range of about 420 nm to about 680 nm for respective angles of incidence of 0 and 60 degrees, and average reflectances for p-polarized light Rpi0 and for s-polarized light Rsi0 for an infrared wavelength range of about 1000 nm to about 1600 nm for an angle of incidence of 0 degrees. Since these films were modeled as being biaxially stretched, Rpv0≈Rsv0 and Rpi0≈Rsi0. Also provided in the following table is the standard deviation Si0, Sp, Ss of the reflectance in the infrared wavelength range for normally incident light (approximately equal, in these cases, for each of two mutually orthogonal polarization states) and for an incident angle of 60 degrees for p- and s-polarized light, respectively.

| | FIG. 5 | FIG. 6 | FIG. 7 |
|---|---|---|---|
| Rpv0 ≈ Rsv0, % | 9.27 | 9.42 | 9.06 |
| Rpv60, % | 25.84 | 23.02 | 29.14 |
| Rsv60, % | 30.73 | 35.46 | 31.95 |
| Rpi0 ≈ Rsi0, % | 79.83 | 89.09 | 89.06 |
| Sp, % | 1.05 | 2.13 | 2.24 |
| Ss, % | 3.46 | 7.46 | 7.36 |
| Si0, % | 0.88 | 0.88 | 0.87 |

In some embodiments, the multilayer optical film 300 is such that for incident light 230 having an angle of incidence less than about 10 degrees and for at least one polarization state, the multilayer optical film has a first order reflection band 310 comprising an average reflectance of greater than about 70, 75, 78, or 80 percent in an infrared wavelength range extending at least from about 1000 nm to about 1600 nm. In some embodiments, the average reflectance in the infrared wavelength range is less than about 99, 98, 97, 96, 95, 94, 93, 92, 91, or 90 percent, for example. In some embodiments, for the incident light having the angle of incidence less than about 10 degrees and for at least one polarization state, the multilayer optical film 300 has an average reflectance of less than about 15, 14, 13, 12, 11, 10, 9.5 percent in a visible wavelength range of about 420 nm to about 680 nm. For example, the average reflectance in the visible wavelength range can be in a range of about 5 to about 14 percent. In some embodiments, the incident light is a p-polarized incident light (e.g., 231 or 230 having polarization state 131) in an incident plane (e.g., the incident plane comprising the x-direction along which the refractive indices used to define the f-ratios are specified). In this case, the at least one polarization state can be the p-polarization state 131 of the p-polarized incident light. In some embodiments, the incident light is an s-polarized incident light (e.g., 232 or 230 having polarization state 132) in an incident plane (e.g., the incident plane comprising the x-direction along which the refractive indices used to define the f-ratios are specified). In this case, the at least one polarization state can be the s-polarization state 132 of the s-polarized incident light. In some embodiments, the at least one polarization state includes two mutually orthogonal polarization states.

In some embodiments, for a p-polarized incident light 231 in an incident plane (e.g., xz-plane) and for a predetermined angle of incidence θ in a range of about 45 degrees to about 75 degrees, the multilayer optical film 300 has an average reflectance in a range of about 18 percent to about 35 percent in the visible wavelength range. The predetermined angle of incidence θ can be at least about 50, 55, or 60 degrees. The predetermined angle of incidence θ can be up to about 70 or 65 degrees, for example. The average reflectance in the visible wavelength range can be at least about 19, 20, 21, 22, or 23 percent. The average reflectance in the visible wavelength range can be up to about 34, 33, 32, 31, 30 percent. In some embodiments, for the p-polarized incident light and the predetermined angle of incidence, the multilayer optical film 300 has a second order reflection band 320 of the first order reflection band 310 where the second order reflection band comprises the average reflectance in the visible wavelength range.

In some embodiments, for a p-polarized incident light (e.g., 230 with polarization state 131) in an incident plane (e.g., the xz-plane comprising the x-direction): for an angle of incidence less than about 10 degrees, the multilayer optical film 300 has a first order reflection band 310 comprising an average reflectance of greater than about 70 percent (or in a range described elsewhere herein) in an infrared wavelength range extending at least from about 1000 nm to about 1600 nm. In some such embodiments, or in other embodiments, for an s-polarized incident light (e.g., 230 with polarization state 132) in the incident plane (xz-plane) and for an angle of incidence less than about 10 degrees, the multilayer optical film has an average reflectance of greater than about 70 percent (or in a range described elsewhere herein) in the infrared wavelength range. In some such embodiments, or in other embodiments, for an s-polarized incident light (e.g., 230 with polarization state 132) in the incident plane and for an angle of incidence less than about 10 degrees, the multilayer optical film has an average reflectance of less than about 15 percent (or in a range described elsewhere herein) in the visible wavelength range. In some such embodiments, or in other embodiments, for an s-polarized incident light (e.g., 232) in the incident plane and for the predetermined angle of incidence θ, the multilayer optical film has an average reflectance in a range of about 18, 19, 20, 21, 22, or 23 percent to about 50 percent in the visible wavelength range. The average reflectance in the visible range for the s-polarized incident light and for the predetermined angle of incidence θ can be up to about 45, 40, or 35 percent, for example. For the predetermined angle of incidence θ and the visible wavelength range, the average reflectance for the s-polarized incident light can be greater than the average reflectance for the p-polarized incident light (e.g., by at least a factor of about 1.1, 1.2, 1.3, or 1.4).

The infrared wavelength range extending at least from about 1000 nm to about 1600 nm can extend below about 1000 nm and/or can extend above about 1600 nm. In some embodiments, the infrared wavelength range extends at least from about 950, 925, or 900 nm to about 1700. The infrared wavelength range can extend up to about 1750, 1800, 1850, or 1900 nm, for example.

In some embodiments, for the p-polarized incident light (e.g., 230 with polarization state 131) in the incident plane (e.g., xz-plane) and for the angle of incidence less than about 10 degrees, or for the angle of incidence less than about 10 degrees and for each of two mutually orthogonal polarization states, the first order reflection band 310 has a first band edge 312 where reflectance of the multilayer optical film along the first band edge generally increases with increasing wavelength. The first band edge 312 has a first band edge wavelength λ1 where the reflectance is about 50 percent. The first band edge wavelength λ1 can be in a range of about 880 nm to about 950 nm, for example. In some embodiments, the reflectance of the multilayer optical film 300 along the first band edge 312 increases at least from about 35, 30, or 25 percent to about 65 percent with increasing wavelength. The reflectance along the first band edge 312 can increase to at least about 70 or 75 percent, for example.

In some embodiments, for the p-polarized incident light in the incident plane and for the angle of incidence less than about 10 degrees, the first order reflection band 310 has a second band edge 314 where reflectance of the multilayer optical film 300 along the second band edge 314 generally decreases with increasing wavelength where the second band edge has a second band edge wavelength λ2 where the reflectance is about 50 percent. The second band edge wavelength λ2 can be in a range of about 1800 nm to about 2000 nm. In some embodiments, the reflectance of the multilayer optical film 300 along the second band edge 314 decreases at least from about 65, 70, or 75 percent to about 35 percent with increasing wavelength. The reflectance along the second band edge 314 can decrease to 30 percent or less, or to 25 percent or less, for example.

In some embodiments, for each of an s-polarized incident light (e.g., 230 with polarization state 132) in the incident plane and the p-polarized incident light (e.g., 230 with polarization state 131) in the incident plane and for the angle of incidence less than about 10 degrees, the multilayer optical film 300 has a reflectance versus wavelength defining a first band edge 312 where reflectance of the multilayer optical film 300 along the first band edge 312 generally increases with increasing wavelength and a second band edge 314 where reflectance of the multilayer optical film 300 along the second band edge generally decreases with increasing wavelength. The first and second band edges 312 and 314 have respective first and second band edge wavelengths λ1 and λ2 where the reflectance is about 50 percent. In some embodiments, the first band edge wavelength λ1 is in a range of about 880 nm to about 950 nm. In some embodiments, the second band edge wavelength λ2 is in a range of about 1800 nm to about 2000 nm.

In some embodiments, the multilayer optical film 300 has a substantially uniform reflectance over a desired wavelength range (e.g., over an infrared range for an angle of incidence less than 10 degrees and/or over a visible range for the predetermined angle of incidence θ). The uniformity can be achieved by a suitable selection of the layer thickness profile, for example, as described further elsewhere herein. In some embodiments, for the p-polarized incident light at the predetermined angle of incidence θ, a standard deviation of a reflectance (expressed as a percent) of the multilayer optical film over the visible wavelength range is less than about 3, 2.8, 2.6, 2.4, or 2.2 percent. Here, since the reflectance is expressed as a percent, the standard deviation of the reflectance is expressed with the same percent “unit”. For example, a standard deviation of 10%, 12%, and 8% is 2% (using N−1 instead of the number of samples N in the denominator of the formular for variance to yield the unbiased sample variance). In some embodiments, for the predetermined angle of incidence θ, the standard deviation for p-polarized visible light is less than the standard deviation for s-polarized visible light. In some embodiments, for the predetermined angle of incidence θ, a reflectance of the multilayer optical film 300 over the visible wavelength range has standard deviations Ss and Sp for the respective s- and p-polarized incident light, where Sp/Ss<1, 0.9, 0.8, 0.7, 0.6, 0.5, 0.4, or 0.35. In some embodiments, for the p-polarized incident light at the predetermined angle of incidence, a standard deviation of a reflectance of the multilayer optical film 300 over the visible wavelength range is less than about 0.15, 0.14, 0.13, 0.12, 0.11, 0.1, 0.09, 0.08, 0.07, 0.06, or 0.05 times the average reflectance in the visible wavelength range. In some embodiments, for the p-polarized incident light at the angle of incidence of less than about 10 degrees, a standard deviation of a reflectance of the multilayer optical film 300 over the infrared wavelength range is less than about 1.5, 1.4, 1.3, 1.2, 1.1, 1, or 0.9 percent. In some embodiments, for incident light having an angle of incidence less than about 10 degrees and for each of two mutually orthogonal polarization states, a standard deviation of a reflectance of the multilayer optical film 300 over the infrared wavelength range is less than about 1.5, 1.4, 1.3, 1.2, 1.1, 1, or 0.9 percent. In some embodiments, for the p-polarized incident light at the angle of incidence of less than about 10 degrees, a standard deviation of a reflectance of the multilayer optical film 300 over the infrared wavelength range is less than about 0.05, 0.045, 0.04, 0.035, 0.03, 0.025, 0.02, 0.018, 0.016, 0.014, 0.012, or 0.01 times the average reflectance in the infrared wavelength range. In some embodiments, for incident light having an angle of incidence less than about 10 degrees and for each of two mutually orthogonal polarization states, a standard deviation of a reflectance of the multilayer optical film 300 over the infrared wavelength range is less than about 0.05, 0.045, 0.04, 0.035, 0.03, 0.025, 0.02, 0.018, 0.016, 0.014, 0.012, or 0.01 times the average reflectance in the infrared wavelength range.

The standard deviation of reflectance over a wavelength range can be determined by measuring the reflectance at 1 nm intervals, for example, over the wavelength range and determining the standard deviation of the resulting reflectance measurements. It has been found that 1 nm intervals provide can be used to provide a generally smooth reflectance versus wavelength curve. The reflectance can be measured using a spectrophotometer, for example. The spectrophotometer can have a spectral resolution of about 1 nm or less, or about 0.8 nm or less, or about 0.6 nm or less, or about 0.4 nm or less, or about 0.2 nm or less. Any noise introduced in the measurement should be sufficiently low that the standard deviation determined from the measurement captures a property of the film, rather than noise introduced by the measurement. For example, a spectrophotometer used for the measurement can have a sufficiently high signal-to-noise ratio that any noise introduced by the spectrophotometer is negligible in determining the standard deviation. Suitable spectrophotometers include those available from PerkinElmer, Inc. (Waltham, MA) under the LAMBDA tradename, such as the LAMBDA 1050 spectrophotometer which is said to have an operating range of 175 nm to 3300 nm and to have a spectral resolution of ≤0.05 nm in the ultraviolet and visible wavelength ranges and a spectral resolution of ≤0.2 nm in the near-infrared wavelength range.

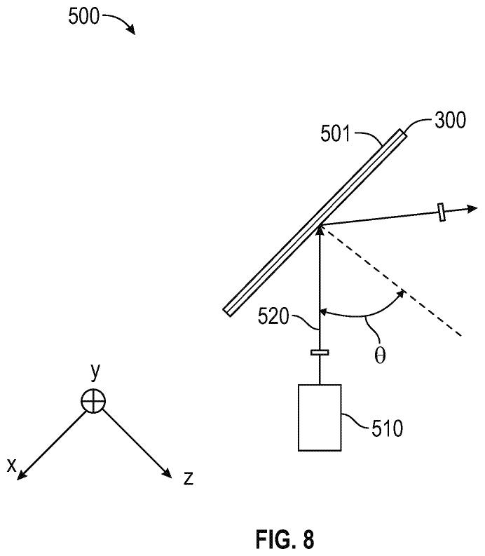

FIG. 8 is a schematic cross-sectional view of a display system 500, according to some embodiments. In some embodiments, a display system 500 includes the multilayer optical film 300 and an image projector 510 configured to project a p-polarized image light 520 toward the multilayer optical film 300. In some embodiments, an automotive windshield 501 includes the multilayer optical film 300. For example, the multilayer optical film 300 may be disposed between, and laminated to, first and second glass layers of an automotive windshield.

In some embodiments, a display system 500 includes an automotive windshield 501 including a multilayer optical film 300 including a plurality of optical repeat units 10, and an image projector 510 configured to project a p-polarized image light 520 toward the automotive windshield 501. Each of the optical repeat units 10 can include at least four sequentially arranged first through fourth individual layers (A, C1, B, C2), where each of the first through fourth individual layers of each optical repeat unit has an average thickness of less than about 500 nm (or in a range described elsewhere herein). In some embodiments, the first through fourth individual layers can have f-ratios in any of the ranges described elsewhere herein. A central ray of the p-polarized image light 520 is in an incident plane (x-z plane) and makes a predetermined angle of incidence θ with the automotive windshield. The predetermined angle of incidence θ can be in a range of about 45 degrees to about 75 degrees, or can be in another range described elsewhere herein. In some embodiments, for a p-polarized incident light in the incident plane: for the incident light incident on the automotive windshield at an angle of incidence less than about 10 degrees (e.g., corresponding to light 230 depicted in FIG. 1), the multilayer optical film 300 has a first order reflection band comprising an average reflectance greater than about 70 percent (or in a range described elsewhere herein) in an infrared wavelength range extending at least from about 1000 nm to about 1600 nm (or in a range described elsewhere herein), and the multilayer optical film has an average reflectance of less than about 15 percent (or in a range described elsewhere herein) in a visible wavelength range of about 420 nm to about 680 nm; and for the incident light incident on the automotive windshield at the predetermined angle of incidence θ (e.g., corresponding to light 231 depicted in FIG. 1), the multilayer optical film 300 has an average reflectance in a range of about 18 percent to about 35 percent (or in a range described elsewhere herein) in the visible wavelength range. In some embodiments, for the p-polarized incident light at the predetermined angle of incidence, a standard deviation of a reflectance of the multilayer optical film over the visible wavelength range is less than about 0.15 (or in a range described elsewhere herein) times the average reflectance in the visible wavelength range. In some embodiments, for the p-polarized incident light at the angle of incidence of less than about 10 degrees, a standard deviation of a reflectance of the multilayer optical film over the infrared wavelength range is less than about 0.05 (or in a range described elsewhere herein) times the average reflectance in the infrared wavelength range. The multilayer optical film 300 used in the display system 500 can have any of the properties described elsewhere herein.

In some embodiments, for an s-polarized incident light (see, e.g., light 230 depicted in FIG. 1 with polarization state 132) incident on the automotive windshield 501 in the incident plane at an angle of incidence less than about 10 degrees, the multilayer optical film 300 has a first order reflection band comprising an average reflectance greater than about 70 percent (or in a range described elsewhere herein) in the infrared wavelength range. In some embodiments, for an s-polarized incident light incident on the automotive windshield 501 in the incident plane at an angle of incidence less than about 10 degrees, the multilayer optical film 300 has an average reflectance of less than about 15 percent (or in a range described elsewhere herein) in the visible wavelength range. In some embodiments, for an s-polarized incident light incident on the automotive windshield 501 in the incident plane at the predetermined angle of incidence θ, the multilayer optical film has an average reflectance in a range of about 18 percent to about 35 percent (or in a range described elsewhere herein) in the visible wavelength range.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A multilayer optical film comprising a plurality of optical repeat units numbering greater than about 10 in total, each of the optical repeat units comprising a plurality of polymeric layers, each polymeric layer of each optical repeat unit having an average thickness of less than about 500 nm, such that:
for incident light having an angle of incidence less than about 10 degrees and for each of two mutually orthogonal polarization states, the multilayer optical film has:
a first order reflection band comprising an average reflectance of greater than about 70 percent in an infrared wavelength range extending at least from about 1000 nm to about 1600 nm, a standard deviation of reflectance of the multilayer optical film over the infrared wavelength range being less than about 0.05 times the average reflectance in the infrared wavelength range; and
an average reflectance of less than about 15 percent in a visible wavelength range of about 420 nm to about 680 nm; and
for a p-polarized incident light in an incident plane and for a predetermined angle of incidence in a range of about 45 degrees to about 75 degrees, the multilayer optical film has an average reflectance in a range of about 18 percent to about 35 percent in the visible wavelength range, a standard deviation of reflectance of the multilayer optical film over the visible wavelength range being less than about 0.15 times the average reflectance in the visible wavelength range.

2. The multilayer optical film of claim 1, wherein for each of the optical repeat units, the plurality of polymeric layers comprises at least four sequentially arranged first through fourth individual layers.

3. The multilayer optical film of claim 2, wherein the first through fourth individual layers has respective indices of refraction nx1 through nx4 in a same in-plane x-direction, respective indices of refraction ny1 through ny4 in a same in-plane y-direction orthogonal to the in-plane x-direction, and respective indices of refraction nz1 through nz4 in a same z-direction orthogonal to each of the in-plane x- and y-directions, the incident plane comprising the in-plane x-direction, wherein for at least one wavelength in the visible wavelength range:
each of |nx1−ny1|, |nx2−ny2|, |nx3−ny3|, |nx4−ny4| is less than 0.03;

|nx1−nx3|>0.1;

|nx2−nx4|<0.03;

|nz1−nz3|<0.03; and

|nz2−nz1|>0.05.

4. The multilayer optical film of claim 3, wherein for the at least one wavelength in the visible wavelength range, nx2 and nx4 are each between nx1 and nx3.

5. The multilayer optical film of claim 2, wherein for each of the optical repeat units, the first through fourth individual layers have respective f-ratios f1 through f4 for respective indices of refraction nx1 through nx4 in a same in-plane x-direction, each of f1 and f3 being in a range of about 0.28 to about 0.4, each of f2 and f4 being in a range of about 0.1 to about 0.22.

6. The multilayer optical film of claim 1, wherein when the optical repeat units are sequentially numbered from the optical repeat unit closest to a outermost first major surface of the multilayer optical film to the optical repeat unit closest to an opposite outermost second major surface of the multilayer optical film, a plot of thickness t of the optical repeat unit versus optical repeat unit number n has a best fit of the form t=a n²+b n+c with a coefficient of determination R² of at least 0.95, a, b, and c being fit parameters, a/b times the total number of optical repeat units being in a range of about 0.45 to about 0.67.

7. The multilayer optical film of claim 1, wherein for an s-polarized incident light in the incident plane and for the predetermined angle of incidence, the multilayer optical film has an average reflectance in a range of about 18 percent to about 50 percent in the visible wavelength range.

8. The multilayer optical film of claim 7, wherein for the predetermined angle of incidence and the visible wavelength range, the average reflectance for the s-polarized incident light is greater than the average reflectance for the p-polarized incident light and a reflectance of the multilayer optical film over the visible wavelength range has standard deviations Ss and Sp for the respective s- and p-polarized incident light, Sp/Ss<0.9.

9. A multilayer optical film comprising a plurality of optical repeat units numbering greater than about 10 in total, each of the optical repeat units having an average total thickness of less than about 1 micrometer and comprising at least four sequentially arranged first through fourth individual layers, wherein for each of the optical repeat units, the first through fourth individual layers have respective f-ratios f1 through f4 for respective indices of refraction nx1 through nx4 in a same in-plane x-direction, each of f1 and f3 being in a range of about 0.28 to about 0.4, each of f2 and f4 being in a range of about 0.1 to about 0.22, such that for a p-polarized incident light in an incident plane comprising the in-plane x-direction:
for an angle of incidence less than about 10 degrees, the multilayer optical film has:
a first order reflection band comprising an average reflectance of greater than about 70 percent in an infrared wavelength range extending at least from about 1000 nm to about 1600 nm; and
an average reflectance of less than about 15 percent in a visible wavelength range of about 420 nm to about 680 nm; and
for a predetermined angle of incidence in a range of about 45 degrees to about 75 degrees, the multilayer optical film has an average reflectance in a range of about 18 percent to about 35 percent in the visible wavelength range.

10. The multilayer optical film of claim 9, wherein for the p-polarized incident light at the predetermined angle of incidence, a standard deviation of a reflectance of the multilayer optical film over the visible wavelength range is less than about 0.15 times the average reflectance in the visible wavelength range.

11. The multilayer optical film of claim 9- or 10, wherein for an s-polarized incident light in the incident plane and for an angle of incidence less than about 10 degrees, the multilayer optical film has an average reflectance of greater than about 70 percent in the infrared wavelength range.

12. A display system comprising the multilayer optical film of claim 9 and an image projector configured to project a p-polarized image light toward the multilayer optical film.

13. A display system, comprising
an automotive windshield comprising a multilayer optical film comprising a plurality of optical repeat units numbering greater than about 10 in total, each of the optical repeat units comprising at least four sequentially arranged first through fourth individual layers, each of the first through fourth individual layers of each optical repeat unit having an average thickness of less than about 500 nm; and
an image projector configured to project a p-polarized image light toward the automotive windshield, a central ray of the p-polarized image light being in an incident plane and making a predetermined angle of incidence with the automotive windshield, the predetermined angle of incidence being in a range of about 45 degrees to about 75 degrees, wherein for a p-polarized incident light in the incident plane:
for the incident light incident on the automotive windshield at an angle of incidence less than about 10 degrees, the multilayer optical film has:
has a first order reflection band comprising an average reflectance greater than about 70 percent in an infrared wavelength range extending at least from about 1000 nm to about 1600 nm; and
an average reflectance of less than about 15 percent in a visible wavelength range of about 420 nm to about 680 nm; and
for the incident light incident on the automotive windshield at the predetermined angle of incidence, the multilayer optical film has an average reflectance in a range of about 18 percent to about 35 percent in the visible wavelength range.

14. The display system of claim 13, wherein for an s-polarized incident light incident on the automotive windshield in the incident plane at an angle of incidence less than about 10 degrees, the multilayer optical film has a first order reflection band comprising an average reflectance greater than about 70 percent in the infrared wavelength range.

15. The display system of claim 13, wherein for the p-polarized incident light at the predetermined angle of incidence, a standard deviation of a reflectance of the multilayer optical film over the visible wavelength range is less than about 0.15 times the average reflectance in the visible wavelength range.

16. A display system comprising the multilayer optical film of claim 1 and an image projector configured to project a p-polarized image light toward the multilayer optical film.
